(19) United States
(12) Patent Application Publication
(10) Pub. No.: US 2015/0205491 A1
(43) Pub. Date: Jul. 23, 2015

(54) SYSTEMS AND METHODS FOR EMPHASIZING CALENDAR EVENTS

(71) Applicant: Google Inc., (US)

(72) Inventor: Wikash Awinash TAHLOE, Brooklyn, NY (US)

(73) Assignee: Google Inc., Mountain View, CA (US)

(21) Appl. No.: 13/802,190

(22) Filed: Mar. 13, 2013

Related U.S. Application Data
(60) Provisional application No. 61/635,038, filed on Apr. 18, 2012.

(51) Int. Cl. G06F 3/0484

(52) U.S. Cl. CPC G06F 3/04842

(57) ABSTRACT

Systems and methods for emphasizing calendar events are provided. In some aspects, a system includes a calendar module configured to generate a plurality of events for a calendar. The system also includes a highlight module configured to automatically apply a visual emphasis feature to a target event of the plurality of events based on a comparison between one or more parameters of the target event and one or more predetermined items of emphasis. The calendar module is configured to display the target event with the visual emphasis feature applied thereto.

### CROSS-REFERENCES TO RELATED APPLICATIONS

The present application claims the benefit of U.S. Provisional Patent Application Ser. No. 61/635,038, entitled “Systems and Methods for Emphasizing Calendar Events,” filed on Apr. 18, 2012, which is hereby incorporated by reference in its entirety for all purposes.

### FIELD

The subject technology generally relates to calendar applications and, in particular, relates to systems and methods for emphasizing calendar events.

### BACKGROUND

A calendar application may be used to create calendar events as well as display the calendar events in a calendar. However, when too many calendar events are displayed in the calendar, it may be difficult for a user to identify and/or locate a particular calendar event displayed in the calendar. This difficulty in identifying and/or locating the particular event can be especially problematic if the particular calendar event is considered to be more important than other calendar events displayed in the calendar.

### SUMMARY

According to various aspects of the subject technology, a system for emphasizing calendar events is provided. The system comprises a calendar module configured to generate a plurality of events for a calendar. The system also comprises a highlight module configured to automatically apply a visual emphasis feature to a target event of the plurality of events based on a comparison between one or more parameters of the target event and one or more predetermined items of emphasis. The calendar module is configured to display the target event with the visual emphasis feature applied thereto.

According to various aspects of the subject technology, a computer-implemented method for emphasizing calendar events is provided. The method comprises automatically applying a visual emphasis feature to a target event of a plurality of events for a calendar. The visual emphasis feature is automatically applied based on a comparison between one or more parameters of the target event and one or more predetermined items of emphasis. The method also comprises displaying the target event with the visual emphasis feature applied thereto.

According to various aspects of the subject technology, a machine-readable medium encoded with executable instructions for emphasizing calendar events is provided. The instructions comprise code for: receiving user input comprising one or more parameters of a target event for a calendar; generating the target event based on the user input; comparing the one or more parameters of the target event to one or more predetermined items of emphasis; automatically applying a visual emphasis feature to the target event based on the comparison between the one or more parameters of the target event and the one or more predetermined items of emphasis; and displaying the target event with the visual emphasis feature applied thereto.

Additional features and advantages of the subject technology will be set forth in the description below, and in part will be apparent from the description, or may be learned by practice of the subject technology. The advantages of the subject technology will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide further understanding of the subject technology and are incorporated in and constitute a part of this specification, illustrate aspects of the subject technology and together with the description serve to explain the principles of the subject technology.

FIG. 1 illustrates an example of a system for emphasizing calendar events, in accordance with various aspects of the subject technology.

FIG. 2 illustrates an example of a method for emphasizing calendar events, in accordance with various aspects of the subject technology.

FIG. 3 illustrates an example of a calendar, in accordance with various aspects of the subject technology.

FIGS. 4A, 4B, and 4C illustrate examples of visual emphasis features, in accordance with various aspects of the subject technology.

FIG. 5 is a block diagram illustrating components of a controller, in accordance with various aspects of the subject technology.

### DETAILED DESCRIPTION

In the following detailed description, numerous specific details are set forth to provide a full understanding of the subject technology. It will be apparent, however, to one ordinarily skilled in the art that the subject technology may be practiced without some of these specific details. In other instances, well-known structures and techniques have not been shown in detail so as not to obscure the subject technology.

Aspects of the subject technology provide an approach to emphasize calendar events so that the emphasized calendar events can be easily identified and/or located by a user. Visual emphasis features may be automatically applied to certain calendar events in order to emphasize these calendar events. According to certain aspects, a visual emphasis feature may be automatically applied to a calendar event based on at least one of a description of the calendar event, a scheduled time of the calendar event, a scheduler of the calendar event, a host of the calendar event, an attendee of the calendar event, a location of the calendar event, a category of the calendar event, and a recurrence frequency of the calendar event. The visual emphasis feature may comprise at least one of a graphical symbol, a border modification, a shading modification, a static size modification, a text modification, an animation, and other visual features useful for emphasizing the calendar event.

For example, the user may create a particular calendar event by specifying a description of the calendar event. If the description contains words that may indicate that this calendar event is important (e.g., contains words like “urgent,” “important,” “critical,” “crucial,” etc.), then the visual emphasis feature may be automatically applied to this calendar event so that it is visually emphasized compared to other calendar events displayed in the calendar. The visual emphasis feature, for example, may be an exclamation mark disposed on or adjacent to the displayed calendar event or may be a border having a color different from other calendar events so that the particular calendar event can be emphasized.

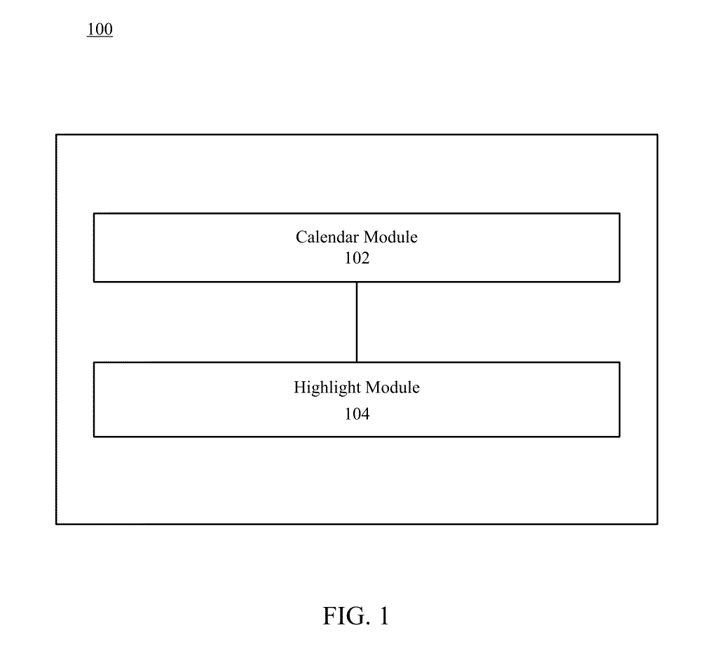

FIG. 1 illustrates an example of system 100 for emphasizing calendar events, in accordance with various aspects of the subject technology. System 100 comprises calendar module 102 and highlight module 104. These modules may be in communication with one another. In some aspects, the modules may be implemented in software (e.g., subroutines and code). In some aspects, some or all of the modules may be implemented in hardware (e.g., an Application Specific Integrated Circuit (ASIC), a Field Programmable Gate Array (FPGA), a Programmable Logic Device (PLD), a controller, a state machine, gated logic, discrete hardware components, or any other suitable devices) and/or a combination of both. Additional features and functions of these modules according to various aspects of the subject technology are further described in the present disclosure.

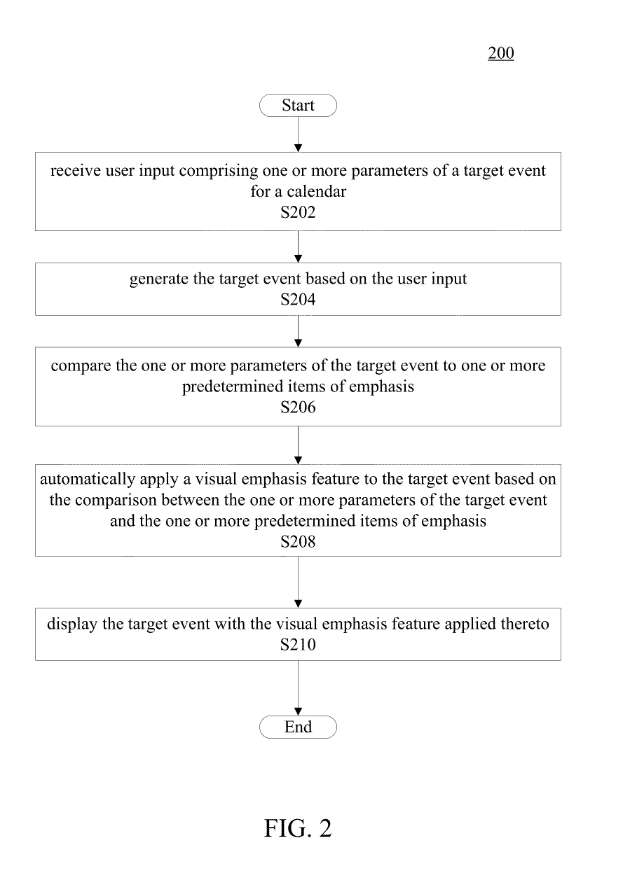

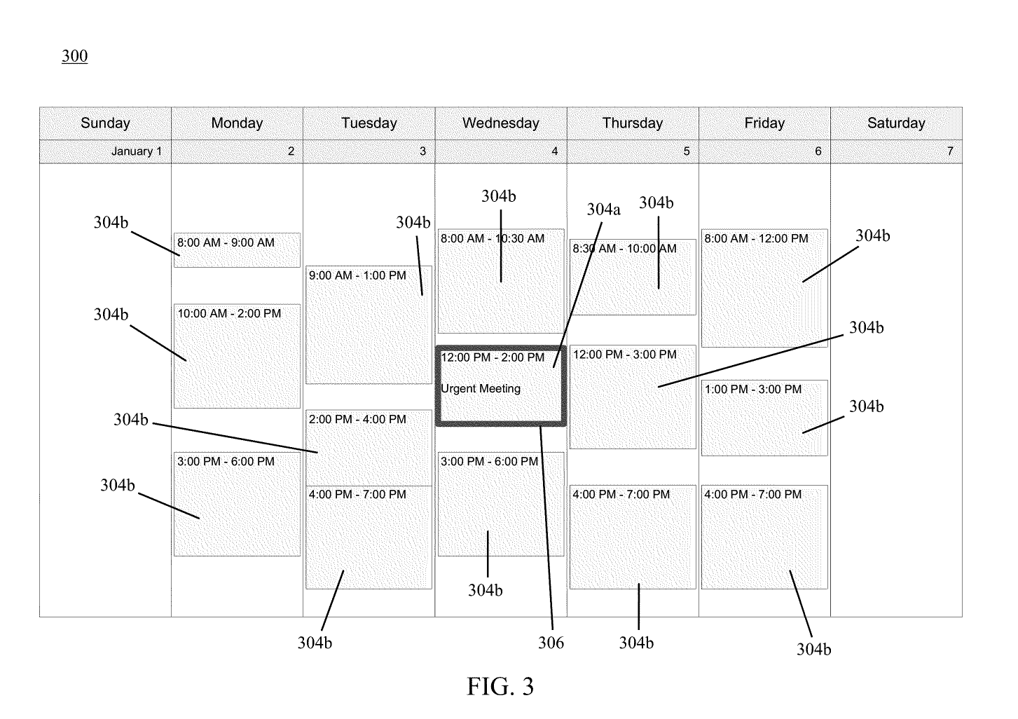

FIG. 2 illustrates an example of method 200 for emphasizing calendar events, in accordance with various aspects of the subject technology. Method 200, for example, may be implemented by system 100. However, method 200 may also be implemented by other systems having different configurations. FIG. 3 illustrates an example of calendar 300, in accordance with various aspects of the subject technology. As shown, calendar 300 comprises a plurality of events 304 (e.g., 304a and 304b) arranged according to their respective time slots in calendar 300. Calendar module 102, for example, may generate the plurality of events 304. Because there are many events 304, it would be difficult for a user of calendar 300 to identify and/or locate a particular event. For a particular event that the user desires to emphasize, it would be beneficial to apply a visual emphasis feature to this event such that it can be easily identified and/or located by the user. Such an event may be referred to herein as a target event, which is shown in FIG. 3 as target event 304a with visual emphasis feature 306 applied thereto. Visual emphasis feature 306 is a border modification of target event 304a, thereby making a border of target event 304a thicker and with a different color compared to the borders of other events 304b. As a result, target event 304a is visually emphasized relative to other events 304b, thereby making target event 304a more noticeable to the user.

Referring to FIGS. 1, 2, and 3, calendar module 102 may receive user input for generating target event 304a, according to step S202. The user input may comprise one or more parameters of target event 304a that provide useful information for generating target event 304a. For example, the one or more parameters of target event 304a may comprise at least one of a description of target event 304a (e.g., “Urgent meeting,” “Call with John,” “Jane's Birthday,” “5 Year Anniversary,” etc.), a scheduled time of target event 304a (e.g., date, hour, duration, etc.), a scheduler of target event 304a (who may or may not be the user), a host of target event 304a (who may or may not be the user), an attendee of target event 304a (who may or may not be the user), a location of target event 304a, a category of target event 304a (e.g., a high priority designation, a medium priority designation, a low priority designation, etc.), and a recurrence frequency of target event 304a (e.g., a number of times target event 304a is specified to recur). According to step S204, calendar module 102 may generate target event 304a based on the user input.

According to step S206, highlight module 104 may compare the one or more parameters of target event 304a to one or more predetermined items of emphasis. In some aspects, each predetermined item of emphasis may be a parameter whose occurrence in a particular event may indicate a need for emphasizing such an event to the user. Comparing the one or more parameters of target event 304a to the one or more predetermined items of emphasis may allow system 100 to determine whether or not target item 304a is an event that visual emphasis feature 306 should be applied to. For example, if the one or more parameters of target event 304a match the one or more predetermined items of emphasis, then highlight module 104 may apply visual emphasis feature 306 to target event 304a.

According to certain aspects, the one or more predetermined items of emphasis may comprise at least one of a description of emphasis (e.g., words and/or phrases that may be designated for emphasis such as “urgent,” “important,” “crucial,” etc.), a time of emphasis (e.g., a particular date, hour, duration, etc. that may be designated for emphasis), a scheduler of emphasis (e.g., a particular person scheduling an event who may be designated for emphasis), a host of emphasis (e.g., a particular host who may be designated for emphasis), an attendee of emphasis (e.g., a particular attendee who may be designated for emphasis), a location of emphasis (e.g., a particular location designated for emphasis), a category of emphasis (e.g., a particular category that may be designated for emphasis), and a recurrence frequency of emphasis (e.g., a particular recurrence frequency that may be designated for emphasis).

In some aspects, a parameter of target event 304a may be a description of target event 304a, and a predetermined item of emphasis may be a description of emphasis. Thus, if the description of target event 304a matches the description of emphasis, then visual emphasis feature 306 may be applied to target event 304a. For example, the description of emphasis may include words or phrases such as “urgent,” “important,” or “crucial.” As shown in FIG. 3, the description of target event 304a is “Urgent Meeting.” Because the word “urgent” in the description of target event 304a matches the description of emphasis (e.g., the word “urgent”), highlight module 104 may apply visual emphasis feature 306 to target event 304a. The description of emphasis is not limited to words related to a sense of urgency. In some aspects, the description of emphasis may include words or phrases that may describe something that is specifically important to the user. For example, if the user considers telephone call events as important, the description of emphasis may include the word “call.” Thus, a description of target event 304a such as “call John” may elicit a match with the description of emphasis. In such a case, visual emphasis feature 306 may be applied to target event 304a as well.

In some aspects, a parameter of target event 304a may be a time of target event 304a, and a predetermined item of emphasis may be a time of emphasis. Thus, if the time of target event 304a matches the time of emphasis, then visual emphasis feature 306 may be applied to target event 304a. For example, the time of emphasis may include a particular time or particular duration of time that is considered important to the user (e.g., any event that is over two hours and/or any event scheduled on Mondays). Thus, in this example, if the time of target event 304a exceeds three hours and/or is scheduled on a Monday, then visual emphasis feature 306 may be applied to target event 304a.

In some aspects, a parameter of target event 304a may be a scheduler of target event 304a, and a predetermined item of emphasis may be a scheduler of emphasis. Thus, if the scheduler of target event 304a matches the scheduler of emphasis, then visual emphasis feature 306 may be applied to target event 304a. For example, the scheduler of emphasis may be a particular person whose scheduled events may be considered particularly important for the user to attend (e.g., an assistant of the user's boss). Thus, in this example, if the scheduler of target event 304a is the assistant of the user's boss, then visual emphasis feature 306 may be applied to target event 304a.

In some aspects, a parameter of target event 304a may be a host of target event 304a, and a predetermined item of emphasis may be a host of emphasis. Thus, if the host of target event 304a matches the host of emphasis, then visual emphasis feature 306 may be applied to target event 304a. For example, the host of emphasis may be a particular person whose events may be considered particularly important for the user to attend (e.g., the user's boss, client, friend, and/or family member). Thus, in this example, if the host of target event 304a is the user's boss, client, friend, and/or family member, then visual emphasis feature 306 may be applied to target event 304a.

In some aspects, a parameter of target event 304a may be an attendee of target event 304a, and a predetermined item of emphasis may be an attendee of emphasis. Thus, if the attendee of target event 304a matches the attendee of emphasis, then visual emphasis feature 306 may be applied to target event 304a. For example, the attendee of emphasis may be a particular person whose participation in an event may be considered particularly important to the user (e.g., the user's boss, client, friend, and/or family member). Thus, in this example, if the attendee of target event 304a is the user's boss, client, friend, and/or family member, then visual emphasis feature 306 may be applied to target event 304a.

In some aspects, a parameter of target event 304a may be a location of target event 304a, and a predetermined item of emphasis may be a location of emphasis. Thus, if the location of target event 304a matches the location of emphasis, then visual emphasis feature 306 may be applied to target event 304a. For example, the location of emphasis may be a particular place at which events may be considered particularly important to the user for the user to attend (e.g., a workplace, a particular city, a particular person's address). Thus, in this example, if the location of target event 304a is the workplace, city or address specified by the location of emphasis, then visual emphasis feature 306 may be applied to target event 304a.

In some aspects, a parameter of target event 304a may be a category of target event 304a, and a predetermined item of emphasis may be a category of emphasis. Thus, if the category of target event 304a matches the category of emphasis, then visual emphasis feature 306 may be applied to target event 304a. For example, the category of emphasis may be a particular category an event is categorized under that may be considered particularly important to the user (e.g., a high priority designation or a medium priority designation). Thus, in this example, if the category of target event 304a corresponds to a high priority designation or a medium priority designation, then visual emphasis feature 306 may be applied to target event 304a.

In some aspects, a parameter of target event 304a may be a recurrence frequency of target event 304a, and a predetermined item of emphasis may be a recurrence frequency of emphasis. Thus, if the recurrence frequency of target event 304a matches the recurrence frequency of emphasis, then visual emphasis feature 306 may be applied to target event 304a. For example, the recurrence frequency of emphasis may be a number of times a particular event is specified to recur that the user may consider particularly important (e.g., a recurrence of at least four times). Thus, in this example, if the recurrence frequency of target event 304a is at least four times, then visual emphasis feature 306 may be applied to target event 304a.

According to certain aspects of the subject technology, the predetermined items of emphasis can be user selected. For example, at least one of the one or more predetermined items of emphasis may be selected by the user of calendar 300. As discussed above, the user may consider telephone call events to be particularly important. Thus, the user may specify the word “call” as a description of emphasis. In some aspects, the predetermined items of emphasis can be generated automatically by highlight module 104. For example, highlight module 104 may generate at least one of the one or more predetermined items of emphasis based on a number of previous occurrences of a corresponding parameter of at least one of the plurality of events 304. In some aspects, if a particular parameter of the plurality events 304 in calendar 300 frequently occurs (e.g., an event 304 is generated at least a certain number of times, each time specifying in its description a “call”), then an item of emphasis may be generated based on that parameter (e.g., a description of emphasis comprising the word “call” may be generated).

According to step S208, highlight module 104 may automatically apply visual emphasis feature 306 to target event 304a based on the comparison between the one or more parameters of target event 304a and the one or more predetermined items of emphasis. For example, as discussed above, highlight module 104 may apply visual emphasis feature 306 to target event 304a if the one or more parameters of target event 304a matches the one or more predetermined items of emphasis. In some aspects, highlight module 104 may refrain from applying visual emphasis feature 306 to other events 304b of calendar 300 so that target event 304a is more noticeable than the other events 304b.

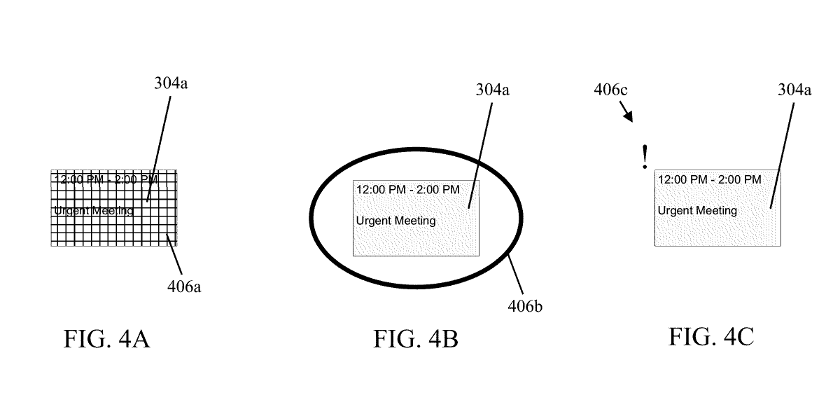

Although visual emphasis feature 306 is shown in FIG. 3 as a border modification of target event 304a, visual emphasis feature 306 may comprise other visual features applied to target event 304a to emphasize target event 304a over other events 304b, such as at least one of a graphical symbol, a shading modification, a static size modification, a text modification, and an animation. If visual emphasis feature 306 comprises an animation, the animation may include a rotation, a translation, a dynamic size modification, and/or a blinking effect. Highlight module 104 may apply the animation for a predetermined duration such as for at least three seconds so that the user may notice target event 304a. However, highlight module 104 may apply the animation for greater than three seconds or less than three seconds depending on the user's preference. FIGS. 4A, 4B, and 4C illustrate other examples of visual emphasis features 406a, 406b, and 406c that can be applied to target event 304a, in accordance with various aspects of the subject technology. For example, as shown in FIG. 4A, visual emphasis feature 406a is a visual grid pattern applied to target event 304a. In FIG. 4B, visual emphasis feature 406b is an ellipse that circles target event 304a. In FIG. 4C, visual emphasis feature 406c is an exclamation mark disposed adjacent to target event 304a.

After visual emphasis feature 306 is applied to target event 304a, target event 304a may be displayed. Referring to FIGS. 1, 2, and 3, calendar module 102 may display target event 304a with visual emphasis feature 306 applied thereto, according to step S210.

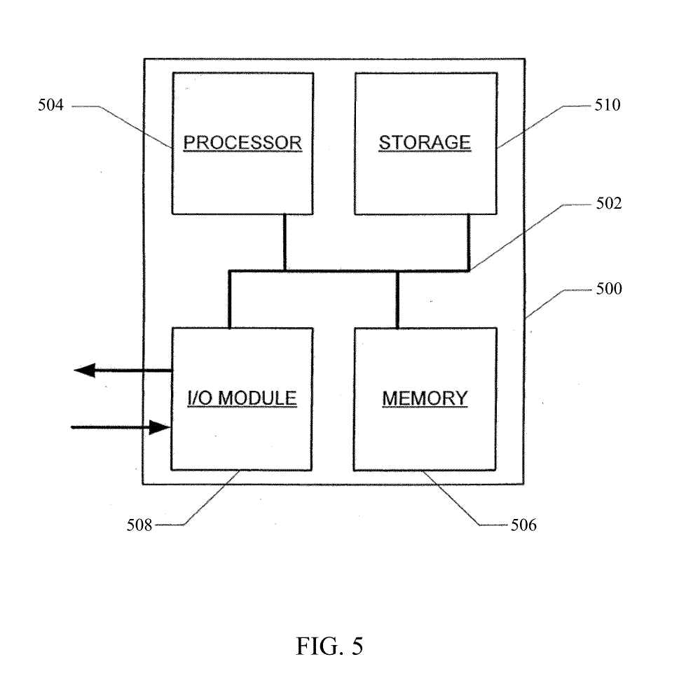

FIG. 5 is a block diagram illustrating components of controller 500, in accordance with various aspects of the subject technology. Controller 500 comprises processor module 504, storage module 510, input/output (I/O) module 508, memory module 506, and bus 502. Bus 502 may be any suitable communication mechanism for communicating information. Processor module 504, storage module 510, I/O module 508, and memory module 506 are coupled with bus 502 for communicating information between any of the modules of controller 500 and/or information between any module of controller 500 and a device external to controller 500. For example, information communicated between any of the modules of controller 500 may include instructions and/or data. In some aspects, bus 502 may be a universal serial bus. In some aspects, bus 502 may provide Ethernet connectivity.

In some aspects, processor module 504 may comprise one or more processors, where each processor may perform different functions or execute different instructions and/or processes. For example, one or more processors may execute instructions for emphasizing calendar events, and one or more processors may execute instructions for input/output functions. Memory module 506 may be random access memory (“RAM”) or other dynamic storage devices for storing information and instructions to be executed by processor module 504. Memory module 506 may also be used for storing temporary variables or other intermediate information during execution of instructions by processor 504. In some aspects, memory module 506 may comprise battery-powered static RAM, which stores information without requiring power to maintain the stored information. Storage module 510 may be a magnetic disk or optical disk and may also store information and instructions. In some aspects, storage module 510 may comprise hard disk storage or electronic memory storage (e.g., flash memory). In some aspects, memory module 506 and storage module 510 are both a machine-readable medium.

Controller 500 is coupled via I/O module 508 to a user interface for providing information to and receiving information from an operator of system 100. For example, the user interface may be a cathode ray tube (“CRT”) or LCD monitor for displaying information to an operator. The user interface may also include, for example, a keyboard or a mouse coupled to controller 500 via I/O module 508 for communicating information and command selections to processor module 504.

According to various aspects of the subject disclosure, methods described herein are executed by controller 500. Specifically, processor module 504 executes one or more sequences of instructions contained in memory module 506 and/or storage module 510. In one example, instructions may be read into memory module 506 from another machine-readable medium, such as storage module 510. In another example, instructions may be read directly into memory module 506 from I/O module 508, for example from an operator of system 100 via the user interface. Execution of the sequences of instructions contained in memory module 506 and/or storage module 510 causes processor module 504 to perform methods to emphasize calendar events. For example, a computational algorithm for emphasizing calendar events may be stored in memory module 506 and/or storage module 510 as one or more sequences of instructions. Information such as the plurality of events, the visual emphasis feature, the one or more parameters of the target event, the one or more predetermined items of emphasis, the user input, and/or other suitable information may be communicated from processor module 504 to memory module 506 and/or storage module 510 via bus 502 for storage. In some aspects, the information may be communicated from processor module 504, memory module 506, and/or storage module 510 to I/O module 508 via bus 502. The information may then be communicated from I/O module 508 to an operator of system 100 via the user interface.

One or more processors in a multi-processing arrangement may also be employed to execute the sequences of instructions contained in memory module 506 and/or storage module 510. In some aspects, hard-wired circuitry may be used in place of or in combination with software instructions to implement various aspects of the subject disclosure. Thus, aspects of the subject disclosure are not limited to any specific combination of hardware circuitry and software.

The term “machine-readable medium,” or “computer-readable medium,” as used herein, refers to any medium that participates in providing instructions to processor module 504 for execution. Such a medium may take many forms, including, but not limited to, non-volatile media and volatile media. Non-volatile media include, for example, optical or magnetic disks, such as storage module 510. Volatile media include dynamic memory, such as memory module 506. Common forms of machine-readable media or computer-readable media include, for example, floppy disk, a flexible disk, hard disk, magnetic tape, any other magnetic medium, a CD-ROM, DVD, any other optical medium, punch cards, paper tape, any other physical mediums with patterns of holes, a RAM, a PROM, an EPROM, a FLASH EPROM, any other memory chip or cartridge, or any other medium from which a processor can read.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

A phrase such as “an aspect” does not imply that such aspect is essential to the subject technology or that such aspect applies to all configurations of the subject technology. A disclosure relating to an aspect may apply to all configurations, or one or more configurations. An aspect may provide one or more examples of the disclosure. A phrase such as an “aspect” may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples of the disclosure. A phrase such an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples of the disclosure. A phrase such as a “configuration” may refer to one or more configurations and vice versa.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” The term “some” refers to one or more. All structural and functional equivalents to the elements of the various configurations described throughout this disclosure that are known or later come to be known to those of ordinary skill in the art are expressly incorporated herein by reference and intended to be encompassed by the subject technology.

1. A system for emphasizing calendar events, the system comprising:
a memory comprising instructions; and
one or more processors configured to execute the instructions, the instructions comprising:
a calendar module configured to generate a plurality of events for a calendar; and
a highlight module configured to automatically apply a visual emphasis feature to a target event of the plurality of events based on a match between one or more parameters of the target event and one or more predetermined parameters of emphasis,
wherein the calendar module is configured to display the target event with the visual emphasis feature applied thereto.

2. The system of claim 1, wherein the visual emphasis feature comprises at least one of a graphical symbol, a border modification, a shading modification, a static size modification, a text modification, and an animation.

3. The system of claim 2, wherein the animation comprises at least one of a rotation, a translation, a dynamic size modification, and a blinking effect.

4. The system of claim 2, wherein the highlight module is configured to apply the animation for a predetermined duration.

5. The system of claim 1, wherein the highlight module is configured to refrain from applying the visual emphasis feature to other events of the plurality of events.

6. The system of claim 1, wherein the one or more parameters of the target event comprise at least one of a description of the target event, a scheduled time of the target event, a scheduler of the target event, a host of the target event, an attendee of the target event, a location of the target event, a category of the target event, and a recurrence frequency of the target event.

7. The system of claim 1, wherein the one or more predetermined parameters of emphasis comprise at least one of a description of emphasis, a time of emphasis, a scheduler of emphasis, a host of emphasis, an attendee of emphasis, a location of emphasis, a category of emphasis, and a recurrence frequency of emphasis.

8. The system of claim 1, wherein at least one of the one or more predetermined parameters of emphasis is determined by a user.

9. The system of claim 1, wherein the highlight module is configured to generate at least one of the one or more predetermined parameters of emphasis based on a number of previous occurrences of a corresponding parameter of at least one of the plurality of events.

10. The system of claim 1, wherein the highlight module is configured to compare the one or more parameters of the target event to the one or more predetermined parameters of emphasis.

11. (canceled)

12. The system of claim 1, wherein the calendar module is configured to receive user input for generating the target event.

13. The system of claim 12, wherein the calendar module is configured to generate the target event based on the user input.

14. The system of claim 12, wherein the user input comprises the one or more parameters of the target event.

15. A computer-implemented method for emphasizing calendar events, the method comprising:
automatically applying a visual emphasis feature to a target event of a plurality of events for a calendar, the visual emphasis feature being automatically applied based on a match between one or more parameters of the target event and one or more predetermined parameters of emphasis; and
displaying the target event with the visual emphasis feature applied thereto.

16. The method of claim 15, further comprising:
receiving user input for generating the target event; and
generating the target event based on the user input.

17. The method of claim 15, wherein the one or more parameters of the target event comprise at least one of a description of the target event, a scheduled time of the target event, a scheduler of the target event, a host of the target event, an attendee of the target event, a location of the target event, a category of the target event, and a recurrence frequency of the target event.

18. The method of claim 15, wherein the one or more predetermined parameters of emphasis comprise at least one of a description of emphasis, a time of emphasis, a scheduler of emphasis, a host of emphasis, an attendee of emphasis, a location of emphasis, a category of emphasis, and a recurrence frequency of emphasis.

19. A non-transitory machine-readable medium encoded with executable instructions for emphasizing calendar events, the instructions comprising code for:
receiving user input comprising one or more parameters of a target event for a calendar;
generating the target event based on the user input;
comparing the one or more parameters of the target event to one or more predetermined parameters of emphasis;
automatically applying a visual emphasis feature to the target event based on a match between the one or more parameters of the target event and the one or more predetermined parameters of emphasis; and
displaying the target event with the visual emphasis feature applied thereto.

20. The non-transitory machine-readable medium of claim 19, wherein the visual emphasis feature comprises at least one of a graphical symbol, a border modification, a shading modification, a static size modification, a text modification, and an animation.

21. The non-transitory machine-readable medium of claim 19, wherein the instructions further comprise code for generating at least one of the one or more predetermined parameters of emphasis based on a number of previous occurrences of a corresponding parameter of at least one of the plurality of events.
